(19) United States
(12) Patent Application Publication
(10) Pub. No.: US 2005/0277008 A1
(43) Pub. Date: Dec. 15, 2005

(54) Equalizer channel in fuel cells

(76) Inventors: Rainer Pechtoid, Russelsheim (DE); Thorsten Rohwer, Trebur (DE)

Correspondence Address: HARNESS, DICKEY & PIERCE, P.L.C., P.O. BOX 828, BLOOMFIELD HILLS, MI, 48303, US

(21) Appl. No.: 10/867,898

(22) Filed: Jun. 15, 2004

(51) Int. Cl. H01M 8/10

(52) U.S. Cl. 429/34; 429/129

(57) ABSTRACT

A fuel cell stack includes an inlet header that distributes a reactant across the fuel cell stack and an equalizer channel that is in fluid communication with the inlet header. The equalizer channel equalizes a pressure of the reactant across a portion of the fuel cell stack. A plurality of reactant flow fields are in fluid communication with the equalizer channel. A reactant flow within the equalizer channel is distributed through the plurality of reactant flow fields.

### FIELD OF THE INVENTION

The present invention relates to fuel cells, and more particularly to an equalizer channel in a fuel cell stack.

### BACKGROUND OF THE INVENTION

Fuel cells produce electricity through electrochemical reaction and have been used as power sources in many applications. Fuel cells can offer significant benefits over other sources of electrical energy, such as improved efficiency, reliability, durability, cost and environmental benefits. Fuel cells may eventually be used in automobiles and trucks. Fuel cells may also power homes and businesses.

There are several different types of fuel cells, each having advantages that may make them particularly suited to given applications. One type is a proton exchange membrane (PEM) fuel cell, which has a membrane sandwiched between an anode and a cathode. To produce electricity through an electrochemical reaction, hydrogen (H₂) is supplied to the anode and air or oxygen (O₂) is supplied to the cathode.

In a first half-cell reaction, dissociation of the hydrogen (H₂) at the anode generates hydrogen protons (H⁺) and electrons (e⁻). Because the membrane is proton conductive, the protons are transported through the membrane. The electrons flow through an electrical load that is connected across the electrodes. In a second half-cell reaction, oxygen (O₂) at the cathode reacts with protons (H⁺) and electrons (e⁻) are taken up to form water (H₂O). Parasitic heat is generated by the reactions and must be regulated to provide efficient operation of the fuel cell stack.

Traditional fuel cell stacks include an inlet header that distributes a reactant across the fuel cell stack to the individual fuel cells that make up the stack. The reactant flow across the inlet header is generally unidirectional and can include turbulence. There is a reactant pressure drop across the fuel cell stack, which leads to an uneven reactant mass flow distribution in the fuel cells.

There are several disadvantages to uneven mass flow across the fuel cells of the fuel cell stack. In one instance, the fuel cells would operate at varying efficiencies creating an uneven temperature distribution across the fuel cell stack. Excessive heat in a lower efficiency fuel cell can result in destruction of that fuel cell. In another instance, water removal from the cells can be uneven. For example, because the reactant flow is utilized to remove excess water from the fuel cells, a fuel cell having a lower reactant mass flow therethrough can build-up too much water, deactivating the fuel cell. A fuel cell having a higher reactant mass flow can remove too much water, potentially drying out and damaging the fuel cell.

### SUMMARY OF THE INVENTION

Accordingly, the present invention provides a fuel cell stack including an inlet header that distributes a reactant across the fuel cell stack and an equalizer channel that is in fluid communication with the inlet header. The equalizer channel equalizes a pressure of the reactant across a portion of the fuel cell stack. A plurality of reactant flow fields are in fluid communication with the equalizer channel. A reactant flow within the equalizer channel is distributed through the plurality of reactant flow fields.

In one feature, the equalizer channel includes multiple segments. Fluid communication is prohibited between adjacent segments.

In another feature, the fuel cell stack further includes an exhaust equalizer channel that is in fluid communication with the plurality of reactant flow fields. The exhaust equalizer channel equalizes a pressure of a reactant exhaust across the fuel cell stack.

In still another feature, the fuel cell stack further includes a plurality of separator plates that are combined to form individual fuel cells of the fuel cell stack. Each separator plate includes an equalizer channel aperture that defines a portion of the equalizer channel.

In yet another feature, the fuel cell stack further includes an outlet header that exhausts reactant exhaust from the fuel cell stack.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic cross-sectional view of a fuel cell stack having an equalizer channel according to the present invention;

FIG. 2 is a plan view of a separator plate of the fuel cell stack of FIG. 1;

FIG. 3 is a schematic cross-sectional view of an alternative fuel cell stack including a multi-section equalizer channel;

FIG. 4 is a schematic cross-sectional view of another alternative fuel cell stack including multiple equalizer channels; and

FIG. 5 is a plan view of a separator plate of the fuel cell stack of FIG. 4.

### DETAILED DESCRIPTION OF THE PREFERRED EMBODIMENTS

The following description of the preferred embodiments is merely exemplary in nature and is in no way intended to limit the invention, its application, or uses.

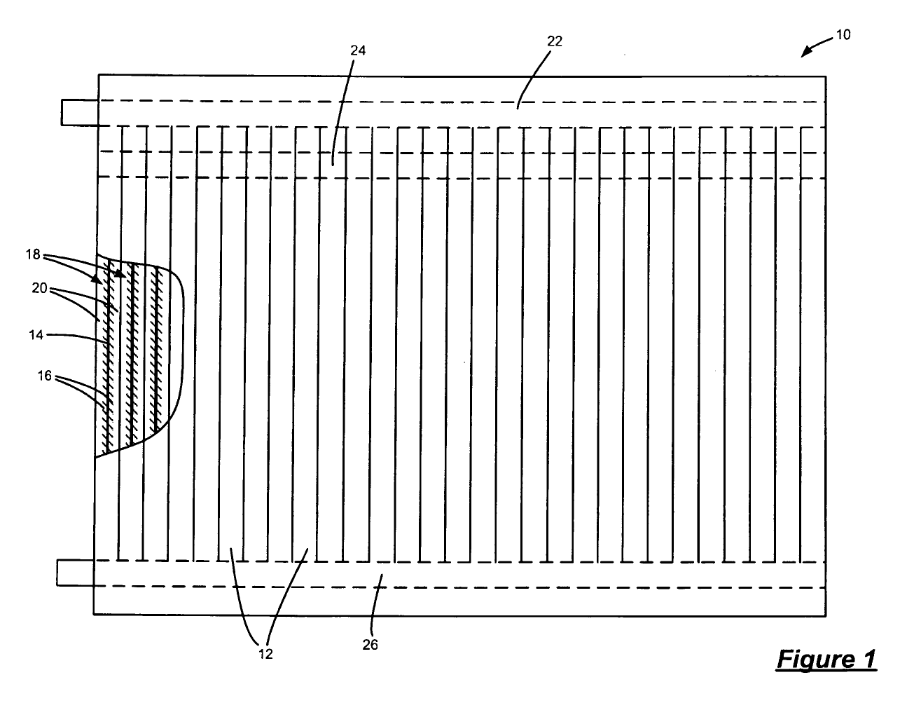

Referring now to FIG. 1, a fuel cell stack 10 according to the present invention is schematically illustrated and includes a partial cross-section. The fuel cell stack 10 includes a plurality of fuel cells 12 stacked together and connected in electrical series. Each fuel cell 12 includes a polymer electrolyte membrane (PEM) 14 sandwiched between diffusion media 16 to form a membrane electrode assembly (MEA) 18. The MEA 18 is sandwiched between separator plates 20. Adjacent separator plates 20 of adjacent fuel cells 12 are combined to define a bipolar plate. The separator plates 20 at the ends of the fuel cell stack 10 define end plates of the fuel cell stack 10.

The separator plates 20 include a reactant flow field, discussed in further detail below, that distributes either a cathode or an anode reactant across the fuel cell. More specifically, the separator plate 20 on one side of the fuel cell 12 distributes the cathode reactant and the separator plate 20 on the other side of the fuel cell 12 distributes the anode reactant. The cathode and anode reactants are diffused through the diffusion media 16 for reaction across the PEM 14.

The fuel cell stack 10 includes an inlet header 22, an equalizer channel 24 and an outlet header 26. A reactant (i.e., anode or cathode) is distributed across the fuel cell stack 10 through the inlet header 22. The reactant flows through the individual separator plates 20 into the equalizer channel. The reactant is distributed to the corresponding reactant flow fields (i.e., anode flow field or cathode flow field) of the individual fuel cells for reaction therein. The exhaust products flow into the outlet header and out the fuel cell stack.

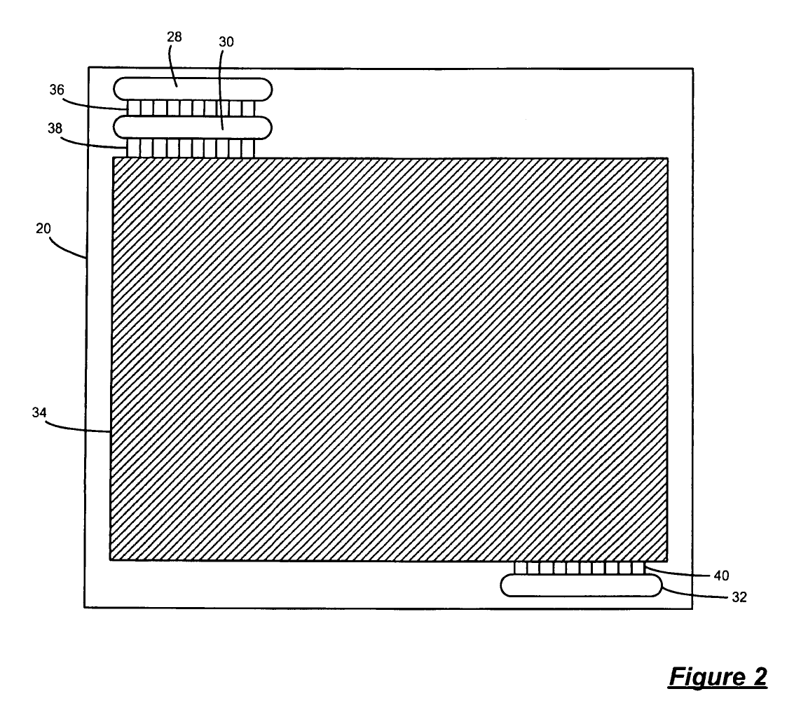

Referring now to FIG. 2, an exemplary separator plate 20 is illustrated for the fuel cell stack 10 of FIG. 1. The separator plate 20 includes an inlet header aperture 28, an equalizer channel aperture 30, an outlet header aperture 32 and a reactant flow field 34. The reactant flow field 34 is schematically illustrated in hatch-line form. It is appreciated that the reactant flow field 34 includes a plurality of flow channels that define a flow field geometry. The flow field geometry can include any flow field geometry known in the art, including, but not limited to serpentine, zigzag, branched channel and the like. The reactant flow field 34 distributes the corresponding reactant (i.e., cathode or anode) across the PEM 14 of the fuel cell 12.

The inlet header aperture 28 is in fluid communication with the equalizer channel aperture 30 via a first set of intermediate channels 36. The equalizer channel aperture 30 is in fluid communication with the channels of the reactant flow field 34 via a second set of intermediate channels 38. The channels of the reactant flow field 34 are in fluid communication with the outlet header aperture 32 via a third set of intermediate channels 40.

The separator plates 20 are stacked adjacently to define the inlet header 22, equalizer channel 24 and outlet header 26. More specifically, adjacent inlet header apertures 28 define the inlet header 20 across the fuel cell stack 10. Similarly, adjacent equalizer channel apertures 30 and adjacent outlet header apertures 32 respectively define the equalizer channel 24 and the outlet header 26.

The reactant initially flows into the fuel cell stack 10 through the inlet header 22. The reactant flow is generally turbulent and there is a pressure drop across the fuel cell stack 10. More specifically, the reactant pressure at the beginning of the inlet header 22 is higher than that at the end of the inlet header 22. This is a result of the single-direction, turbulent flow. The reactant is distributed through the first set of intermediate channels 36 of the individual fuel cells 12 and flows into the equalizer channel 24. Unlike the inlet header 22, there is not a single-direction, reactant flow within the equalizer channel 24. Further, any turbulence in the reactant flow is evenly distributed across the equalizer channel 24. As a result, the reactant pressure is equalized across the fuel cell stack 12 within the equalizer channel 24 and an improved mass flow distribution is achieved into the individual fuel cells 12.

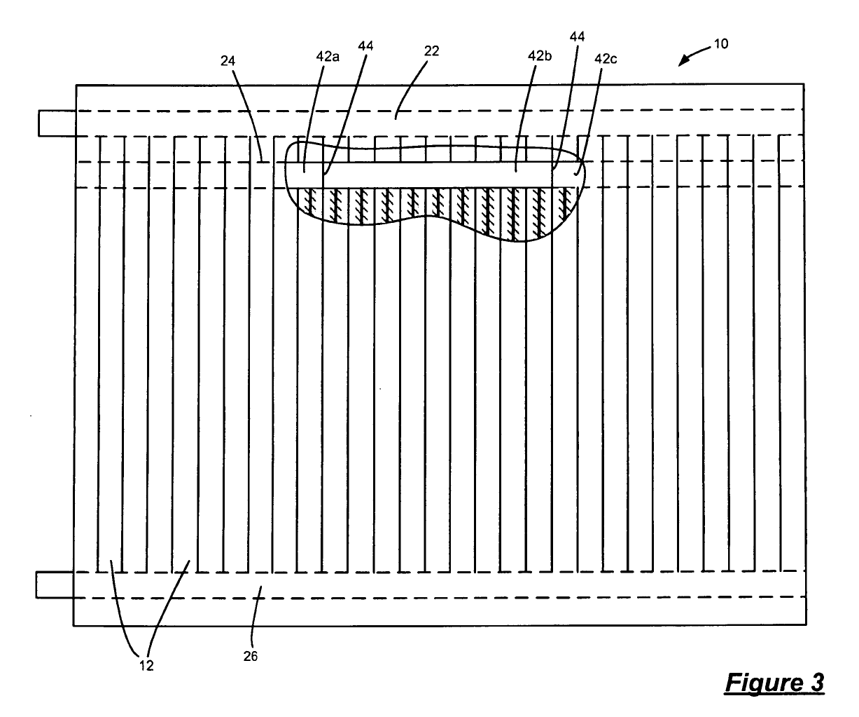

Referring now to FIG. 3, the equalizer channel 24 can be divided into segments 42a,42b,42c, respectively. Although the exemplary illustration of FIG. 3 illustrates three segments 42a,42b,42c, it is anticipated that a varying number of segments 42a,42b,42c can be implemented including two, four, five, six, seven or more. The segments 42a,42b,42c are separated from one another by barriers 44. The reactant initially flows into the fuel cell stack 10 through the inlet header 22 and is distributed through the first set of intermediate channels 36 of the individual fuel cells 12 into the equalizer channel segments 42a,42b,42c. The reactant pressure and turbulence are equalized within the individual segments 42a,42b,42c and are channeled into the respective fuel cells 12 via the second set of intermediate channels 38.

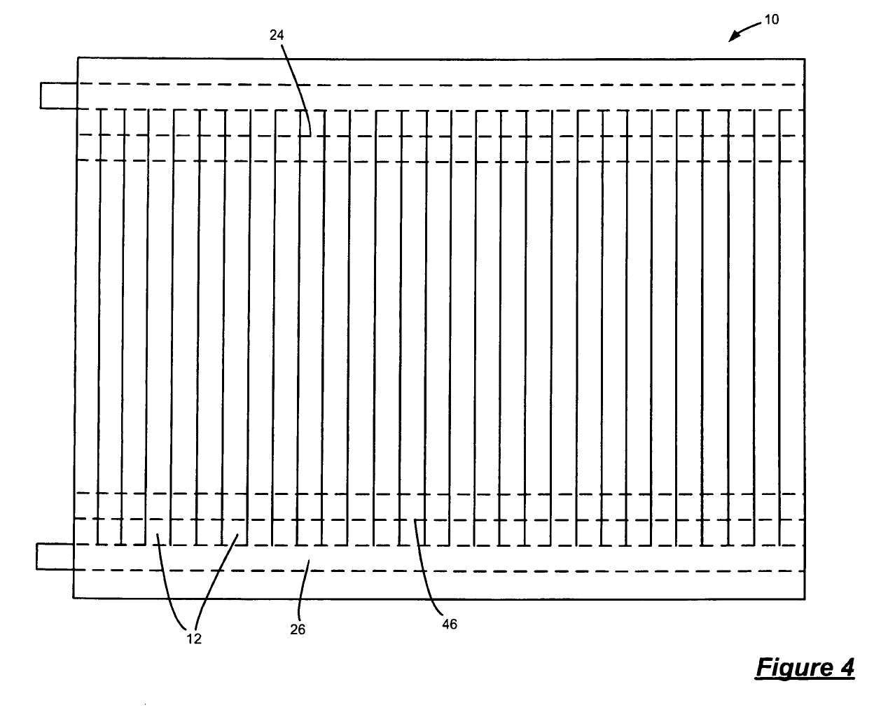

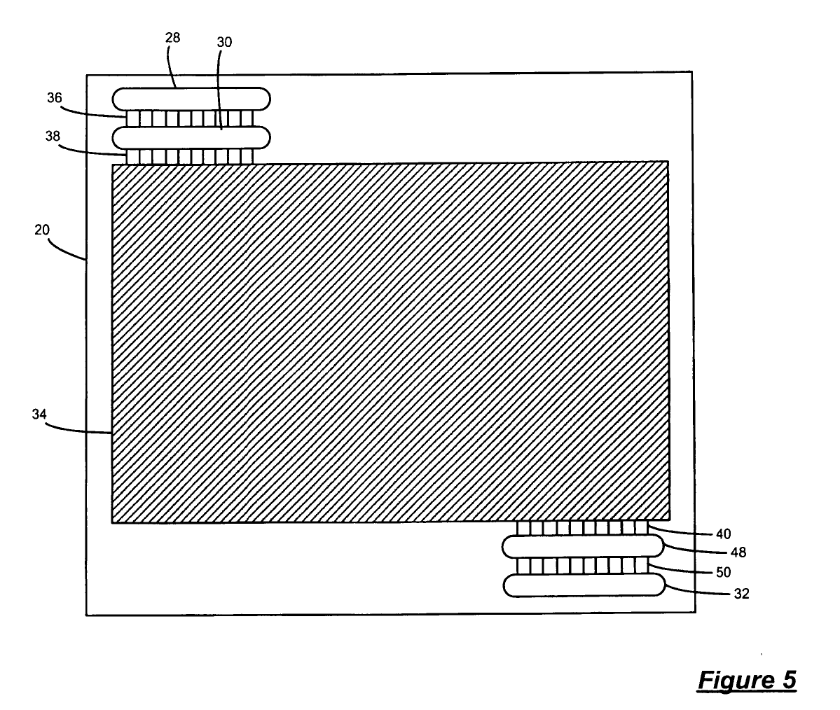

Referring now to FIGS. 4 and 5, it is anticipated that the fuel cell stack 10 can include an exhaust equalizer channel 46 on the outlet side of the fuel cell stack 10. More particularly, the separator plates 20 each include an exhaust equalizer channel aperture 48 disposed between the reactant flow field 34 and the outlet header aperture 32. A fourth set of intermediate channels 50 enable fluid communication between the exhaust equalizer channel aperture 48 and the outlet header aperture 32. The separator plates 20 are stacked adjacently to define the inlet header 22, equalizer channel 24, exhaust equalizer channel 48 and outlet header 26. More specifically, adjacent inlet header apertures 28 and adjacent equalizer channel apertures 30 respectively define the inlet header 22 and equalizer channel 24 across the fuel cell stack 10. Similarly, adjacent exhaust equalizer channel apertures 48 and adjacent outlet header apertures 32 respectively define the exhaust equalizer channel 46 and the outlet header 26.

The reactant initially flows into the fuel cell stack 10 through the inlet header 22 and is distributed through the first set of intermediate channels 36 of the individual fuel cells 12 into the equalizer channel 24. The reactant pressure and turbulence are equalized within the equalizer channel 24 and are directed into the individual fuel cells 12 via the second set of intermediate channels 38. Exhaust from the individual fuel cells 12 flows from the reactant flow field 34 and into the exhaust equalizer channel 46 through the third set of intermediate channels 40. The exhaust pressure and turbulence are equalized within the exhaust equalizer channel 46. The exhaust flows into the outlet header 26 through the fourth set of intermediate channels 50 of the individual fuel cells 12 and out the fuel cell stack 10.

Although the above description is directed to a single equalizer channel associated with the inlet header or a single set of equalizer channels associated with the inlet and exhaust headers for either the cathode or anode reactant, it is appreciated that a second equalizer channel or second set of equalizer channels associated with the other reactant (the other of the cathode and anode reactants) can be included.

The description of the invention is merely exemplary in nature and, thus, variations that do not depart from the gist of the invention are intended to be within the scope of the invention. Such variations are not to be regarded as a departure from the spirit and scope of the invention.

1. A fuel cell stack, comprising:
an inlet header that distributes a reactant across said fuel cell stack;
an equalizer channel that is in fluid communication with said inlet header and that equalizes a pressure of said reactant across a portion of said fuel cell stack; and
a plurality of reactant flow fields that are in fluid communication with said equalizer channel, wherein a reactant flow within said equalizer channel is distributed through said plurality of reactant flow fields.

2. The fuel cell stack of claim 1 wherein said equalizer channel includes multiple segments.

3. The fuel cell stack of claim 2 wherein fluid communication is prohibited between adjacent segments.

4. The fuel cell stack of claim 1 further comprising an exhaust equalizer channel that is in fluid communication with said plurality of reactant flow fields and that equalizes a pressure of a reactant exhaust across said fuel cell stack.

5. The fuel cell stack of claim 1 further comprising a plurality of separator plates that are combined to form individual fuel cells of said fuel cell stack, wherein each separator plate includes an equalizer channel aperture that defines a portion of said equalizer channel.

6. The fuel cell stack of claim 1 further comprising an outlet header that exhausts reactant exhaust from said fuel cell stack.

7. A separator plate of a fuel cell in a fuel cell stack, comprising:
an inlet header aperture that defines a portion of an inlet header that extends across said fuel cell stack;
an equalizer channel aperture connected to said inlet header aperture by an intermediate channel, said equalizer channel aperture defining a portion of an equalizer channel that extends across said fuel cell stack; and
reactant flow field channels connected to said equalizer channel aperture by a channel.

8. The separator plate of claim 7 further comprising an outlet header aperture that is in fluid communication with said reactant flow field and that defines a portion of an outlet header that extends across said fuel cell stack.

9. The separator plate of claim 7 further comprising an exhaust equalizer channel aperture that communicates with said reactant flow field and that defines a portion of an exhaust equalizer channel that extends across said fuel cell stack.

10. A fuel cell stack, comprising:
an inlet header that distributes a reactant across said fuel cell stack;
an equalizer channel that is in fluid communication with said inlet header and that equalizes a pressure of said reactant across a portion of said fuel cell stack; and
a plurality of separator plates that define said inlet header, said equalizer channel and a plurality of reactant flow fields that are in fluid communication with said equalizer channel, wherein a reactant flow within said equalizer channel is distributed through said plurality of reactant flow fields.

11. The fuel cell stack of claim 10 wherein each of said plurality of separator plates include an inlet header aperture that defines a portion of said inlet header.

12. The fuel cell stack of claim 10 wherein each of said plurality of separator plates include an equalizer channel aperture that defines a portion of said equalizer channel.

13. The fuel cell stack of claim 10 wherein said equalizer channel includes multiple segments.

14. The fuel cell stack of claim 13 wherein fluid communication is prohibited between adjacent segments.

15. The fuel cell stack of claim 10 further comprising an exhaust equalizer channel that is in fluid communication with said plurality of reactant flow fields and that equalizes a pressure of a reactant exhaust across said fuel cell stack.

16. The fuel cell stack of claim 15 wherein each of said separator plates includes an exhaust equalizer channel aperture that defines a portion of said exhaust equalizer channel.

17. The fuel cell stack of claim 10 further comprising an outlet header that exhausts reactant exhaust from said fuel cell stack.
